(19) United States
(12) Patent Application Publication
(10) Pub. No.: US 2001/0055267 A1
(43) Pub. Date: Dec. 27, 2001

(54) Disk changer device and disk magazine

(75) Inventors: Kikuo Shimizu, Hitachinaka (JP); Ikuo Nishida, Ebina (JP); Kouhei Takita, Hitachinaka (JP)

Correspondence Address: McDermott, Will & Emery, 600 13th Street, N.W., Washington, DC, 20005-3096, US

(73) Assignee: HITACHI, LTD.

(21) Appl. No.: 09/842,911

(22) Filed: Apr. 27, 2001

(30) Foreign Application Priority Data
May 31, 2000 (JP) 2000-166446

(51) Int. Cl. G11B 17/04; G11B 17/08

(52) U.S. Cl. 369/200; 369/195

(57) ABSTRACT

A disk magazine and disk changer device for holding multiple two-sided disk media wherein the magazine can be turned upside-down so as to allow both sides of the disk media to be utilized. In order to allow handling of two-sided disks, disk transport trays are provided above and below the disk media. A single disk transport tray operates to handle the disk medium above the given tray and below the given tray.

### BACKGROUND OF THE INVENTION

The present invention relates to a disk changer device that interchanges multiple disks and a disk magazine for the same.

Optical disk media have been used as interchangeable media in audio disks, video disks, and computer data recording/playback devices. The ways of disk media use include the use of the disk by itself, the use of cartridges, each of which holds a single disk, and the use of magazines, which hold multiple disks. Due to the need to access multiple disks, changer devices often use magazine media.

Japanese laid-open patent publication number 10-106199 presents an example of a conventional technology of a disk magazine that holds multiple disks. This disk magazine is equipped with a dedicated disk transport tray for each disk. These transport trays are pulled into the device so that the mounted disk is transported into the device. The disk is clamped and rotated at a disk rotation position. When the disk is to be returned back into the magazine, the disk transport tray is returned back into the magazine.

This conventional technology does not take into account the use of optical disk recording/playback media in which both sides can be used, and one direction of the disk magazine is fixed as the top surface.

However, there are optical disk recording/playback media that allow both sides to be used. If multiple two-sided optical disk media are stored in the disk magazine, only one of their sides will be usable.

### SUMMARY OF THE INVENTION

The object of the present invention is to overcome the problem described above and to provide a disk changer device and a disk magazine that allows two-sided use by allowing a disk magazine storing multiple disk media to be turned upside-down and used.

In order to achieve these objects, the following structure is provided.

The present invention provides a disk changer device that includes: a disk magazine equipped with disk transport trays for mounting a plurality of disks; a spindle motor for rotating the disks; a head for playing back information from the disks mounted on the spindle motor; and a tray pulling mechanism pulling the disk transport trays on which the disks are mounted from the disk magazine up to where the disks are at a disk rotation position. The disk magazine holds N disks and N+1 disk transport trays in an alternating manner along a vertical axis of the disk magazine. The disk transport trays include grooves on both sides formed along a thickness axis of the trays. A disk can be mounted on disk transport trays positioned on either side of the disk. The disk magazine can be turned upside-down to allow playback of information recorded on either side of the disks.

The present invention also provides a disk magazine that includes N disks and N+1 disk transport trays arranged in an alternating manner along a thickness axis of the disks. The disk transport trays includes grooves formed on both sides along a thickness axis thereof. A disk is capable of being mounted on disk transport trays positioned on either side of the disk.

Also, to allow the disk magazine to be turned upside-down, the disk magazine is formed to be rotationally symmetrical around an axis parallel to the direction in which the disk magazine is inserted into the disk changer device.

### BRIEF DESCRIPTION OF THE DRAWINGS

FIG. 1 is a drawing for the purpose of describing a conventional disk magazine holding multiple disks.

FIG. 2 is a drawing for the purpose of describing a two-sided disk magazine holding multiple disks according to an embodiment of the present invention.

FIG. 3 is a drawing for the purpose of describing a two-sided disk magazine in which there are (N+1) disk transport trays for N optical disk media.

FIG. 4 shows a see-through drawing as seen from above of a disk magazine holding four optical disk media 2, a drawing indicating a disk transport tray when it is pulled out, and a drawing of a disk magazine as seen from the insertion direction.

FIG. 5 is a drawing for the purpose of describing the function blocks in an optical changer device.

FIG. 6 is a drawing for the purpose of describing how a disk is transported when using side B of a disk with a disk magazine mounted in an optical disk changer device.

FIG. 7 is a drawing for the purpose of describing how a disk is transported when using side B of a disk with a disk magazine mounted in an optical disk changer device.

### DETAILED DESCRIPTION OF THE INVENTION

The following is a description of an embodiment of the present invention, with references to the drawings.

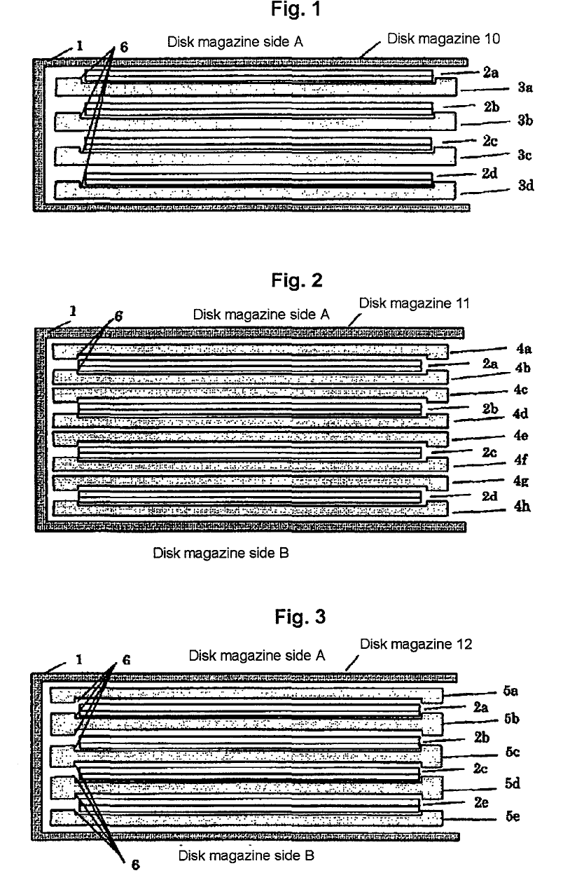

FIG. 1 is a cross-section drawing of a conventional disk magazine 10 housing multiple optical disk media 2. In this figure, a disk magazine 10 is formed from a cylindrical disk case 1, multiple optical disk media 2, and a disk transport tray 3. For the purposes of this description, there are four optical disks and the same number of disk transport trays, each of which correspond to an optical disk to be transported. As the figure shows, if side A of the disk magazine is to be the top surface, the disk medium 2a positioned at the uppermost level will be mounted in a disk transport tray 3a due to its own weight. A disk mounting groove 6 is disposed on the upper surface of the disk transport tray 3a to provide more stable positioning of the disk medium 2a supported by the disk transport tray 3a. The same relationships apply to the disk media 2 and the disk transport trays 3 at the second, the third, and the lowermost levels.

The optical disk media 2 are used by being pulled into an optical disk changer device. To do this, the disk transport tray 3 on which the optical disk medium 2 is mounted is engaged with a pulling mechanism section 36 inside the device, described later, and is transported into the device. It would also be possible to push the disk transport tray into the device using a transport mechanism (not shown in the figures) on the outside of the device. The information is recorded on or played back from the optical disk medium 2 pulled into the device.

When the disk magazine 10 is used with side A serving as the top surface, as shown in the figure, the lower surfaces of the disks will be used. This surface, on which information recording/playback will be performed will be referred to as side A of the disk media.

To return the optical disk medium 2 back into the disk magazine 10, it and the disk transport tray 3 are transported into the disk magazine 10 using the reverse of the path described above.

In the disk magazine 10 in the figure, the disk transport tray 3 is installed below the optical disk medium 2. Thus, if the disk magazine 10 is turned upside-down (rotated 180 deg so that side A of the disk magazine is the bottom surface), it is not possible to pull out the optical disk medium 2 along with the disk transport tray 3.

FIG. 2 shows a cross-section drawing of a disk magazine according to an embodiment of the present invention. This is a two-sided disk magazine that overcomes the problems of disk magazines such as the one from FIG. 1 that can only be used for single sided operations. As the figure shows, disk transport trays 4 are disposed both above and below a single optical disk medium 2. Each disk transport tray 4 is formed with the disk mounting groove 6 described above to position the disk medium. When the disk magazine 11 is to be used with side A as the top surface, the optical disk medium 2a positioned at the uppermost level will be mounted in the disk transport tray 4b, as in FIG. 1. When the optical disk medium 2a is to be used, it is transported into the device along with the disk transport tray 4b. This allows access to side A of the optical disk medium 2a, and the recording and playback of information can be performed.

To use the other side B of the optical disk medium 2a, the disk magazine 11 is turned upside-down so that side B of the disk magazine 11 is the top surface. This causes the optical disk medium 2a to move onto the disk transport tray 4a due to its own weight. If the optical disk medium 2a is to be used, it can be transported into the device along with the disk transport tray 4a. This allows access to side B of the optical disk medium 2a. Thus, when the disk magazine 11 is rotated 180 deg around the insertion direction axis, the disk transport tray on which the optical disk medium 2a is switched. This allows information to be recorded to an played back from both sides of the optical disk medium 2a.

Each of the optical disk media are stored in a similar manner and are provided with two disk transport trays 4. The optical disk medium 2b is provided with a disk transport tray 4c (for side B) and a disk transport tray 4d (for side A), the optical disk medium 2c is provided with a disk transport tray 4e (for side B) and a disk transport tray 4f (for side A), and the optical disk medium 2d is provided with a disk transport tray 4g (for side B) and a disk transport tray 4h (for side A).

FIG. 3 shows a cross-section drawing of a disk magazine according to a first embodiment of the present invention. This structure provides the same features as the disk magazine in FIG. 2, but the number of disk transport trays 4 is reduced. The disk transport tray 4b and the disk transport tray 4c are integrated to form a single two-sided tray 5b. The two-sided tray 5b is used not only for the disk 2a but also for the disk 2b when side B of the disk magazine is facing up.

In the disk magazine 11 shown in FIG. 2, double (2N) the number of disk transport trays 4 is needed for N optical disk media 2. However, in the disk magazine 12, the same features can be provided with (N+1) disk transport trays 5 for N optical disk media. In this figure, four two-sided optical disk media are used and five disk transport trays are provided.

In this figure, mounting grooves 6 for supporting the optical disk media 2 are formed on both sides only for the disk transport trays 5b, 5c, and 5d, which handle disk transport for the disk above and the disk below it. However, it would also be possible to have mounting grooves 6 for supporting the optical disk media 2 formed on both sides for all five disk transport trays 5.

The embodiment description below will refer to the double-sided disk magazine 12 shown in FIG. 3 will be used.

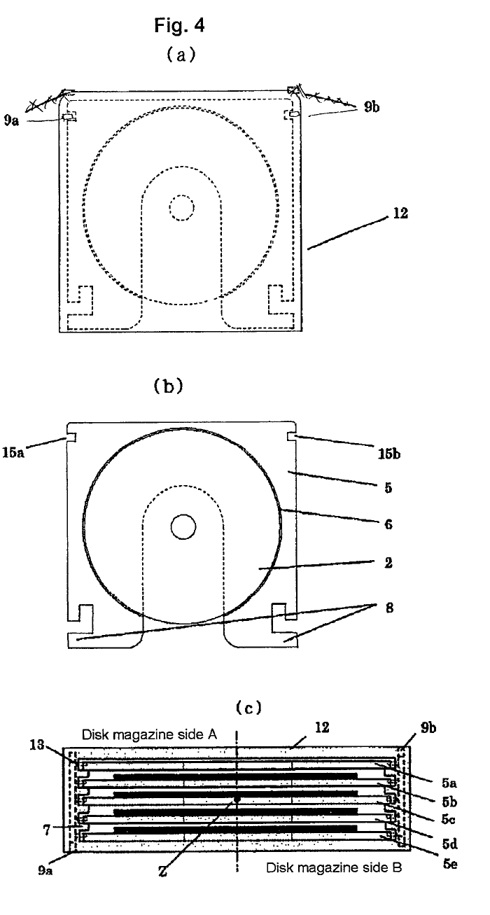

FIG. 4 shows a disk magazine housing four optical disk media 2. FIG. 4 (a) is a see-through drawing as seen from the top surface (side A of the disk magazine). The magazine holds five disk transport trays 5, and each disk transport tray 5 is supported by tray holding latches 9a, 9b so that the trays cannot easily fall out.

FIG. 4 (b) is a drawing as seen from the top of the of the disk transport tray 5 and the optical disk medium 2 when it is completely pulled out from the disk magazine 12. Of the five disk transport trays actually in the disk magazine 12, three of the trays 5b, 5c, and 5d are formed with grooves 6 on both sides to position mounted disks. The trays 5a, 5e are formed with inward-facing positioning grooves 6 to support the optical disk media 2a, 2d.

The disk transport trays 5 are supported by edges 7 formed on the left and right inside the disk case 1. The spacing between the edges is set up so that no load is applied during transport. When a disk transport tray 5 is pulled out from the disk magazine 12 or is returned back into the disk magazine 12, a transport hook 8 disposed on the disk transport tray engages with a pull-out mechanism 36, described later. The optical disk medium 2 and the disk transport tray 5 are transported by drawing in and pushing out the optical disk together with the disk transport tray to and from the optical disk changer device.

FIG. 4 (c) shows the disk magazine 12 from the direction of insertion. Generally, tray holding latches 9 are provided on the disk magazine 12 holding the disk transport trays 5 to prevent the trays from accidentally falling out during handling. In this embodiment, comb-shaped tray holding latches 9a, 9b are attached on the inside of the magazine case. Stoppers 13 of the tray holding latches are, in the normal state, positioned at the center positions between the edges 7 disposed uniformly inside the magazine case 1. The stoppers 13 abut cut-outs 15 shown in FIG. 4 (b) to prevent the disk from being transported. In this case, the latch 9a fits against the cut-out 15a, and the latch 9b fits against the cut-out 15b.

When the disk magazine 12 is mounted in the device, a mechanism in the device pushes up the comb-shaped tray holding latch 9a, moving the stoppers 13 so that they are parallel to the edges 7. This allows the disk transport trays to be transported out from the magazine.

As FIG. 4 (c) shows, the tray holding latches 9a, 9b are disposed at rotationally symmetrical positions for when the disk magazine 12 is rotated 180 deg around an axis parallel to the insertion direction and intersecting a center point Z of the disk magazine 12. In a similar manner, the cut-outs 15 are also disposed on the trays at rotationally symmetrical positions, as shown in FIG. 4 (b).

Thus, the structure is rotationally symmetrical so that the shape of the disk magazine 12 and the heights of the disk transport trays 5 are unchanged even if there is a 180 deg rotation around axis Z. This allows the disk magazine 12 to be used upside-down. Thus, the access position information for the disk transport trays 5 can be used in the same manner even when the magazine is upside-down.

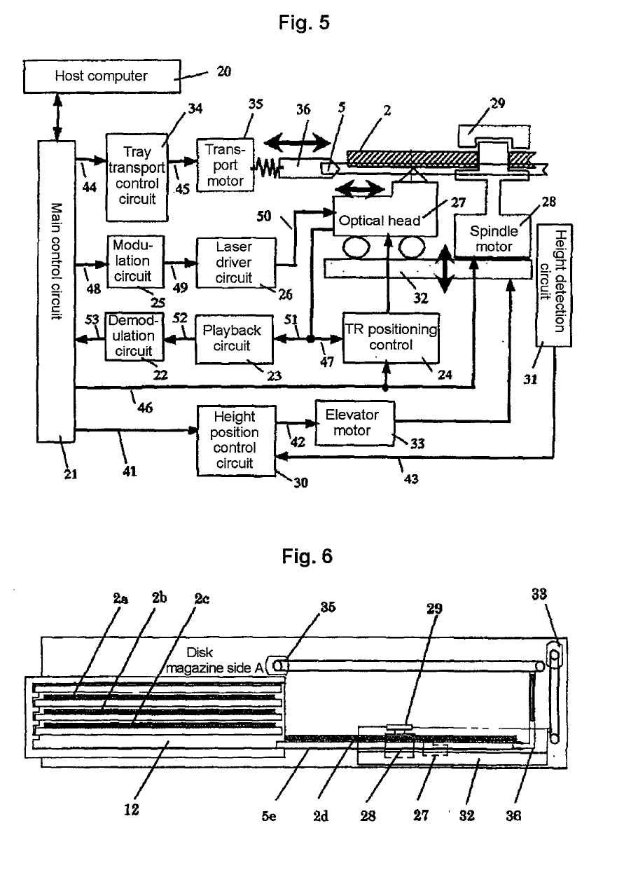

The following is a description, with references to FIG. 5, of an embodiment of an optical disk changer device that records and plays back information by pulling out the disk transport trays 5 from the disk magazine 12, which holds multiple optical disk media 2.

The optical disk changer device shown in this figure includes: a spindle motor rotating the optical disk media 2; an optical head 27 recording and playing back information on the optical disk media 2; and a main control circuit 21 providing overall control for the system in the device. Also included are systems that function under the main control circuit 21: a track positioning control system for the optical head 27; an information recording system; an information playback system; a tray pulling control system performing disk transport; and a height position control system moving the optical head 27, the spindle motor 28, and the like vertically.

The following is a description of how a requested disk medium is selected out of the multiple optical disk media 2 in response to an instruction from a host computer 20 and how information is recorded and played back.

The height position control system is used to transport the disk medium requested by the host computer 20. A predetermined disk height information 41 is sent from the main control circuit 21 to a height position control circuit 30. This circuit converts this information to an elevator driver current 42, which is sent to an elevator motor 33. The elevator motor causes a head base 32 to be moved vertically. When this happens, the movable parts attached to the head base 32 such as the optical head 27 and the spindle motor 28 are moved vertically. The height position controller is informed of a current height information 43 through an external height detection circuit 31 and provides control so that the current height information matches a desired height information.

When the head base 32 is moved to a predetermined height position, the tray pulling control system pulls the optical disk medium 2 to be used into the device. The main control circuit 21 issues a pulling instruction 44 to a tray transport control circuit 34 in order to pull the predetermined disk transport tray 5 in. A transport drive signal 45 in the pulling direction is issued and the transport motor 35 is driven to move the tray pulling mechanism 36 horizontally. Then, the transport hook 8 at the end of the predetermined disk transport tray 5 in the disk magazine 12 is engaged and the tray is pulled in up to the center position of the spindle motor 28.

Next, the elevator motor 33 is driven and the head base 32 is moved slightly upward. Then, the spindle motor 28 lifts up the optical disk medium 2 to raise it slightly off of the disk transport tray 5. A damper 29 secures the optical disk medium 2 to the spindle motor 28.

Then, the optical disk medium 2 is rotated by the spindle motor 28 at a predetermined speed.

Next, the track position control system is used to provide track positioning as indicated by the host computer 20. A track position information 46 and a current track position information 47 needed for this operation are sent to the track positioning control module 24, and the track positioning control module 24 moves the optical head 27 along the radius of the disk.

In the information recording system, a recording information 48 sent from the host computer 20 goes through a modulation circuit 25 and is converted into a recording information code 49 to be recorded. The recording information code is sent to a laser driver circuit 26, where it is converted into a recording driver current 50 based on the recording pattern and sent to the optical head 27. In the optical head 27, the driver current is converted into an optical pulse by a laser driver and a semiconductor laser (not shown in the figures), which is beamed onto the recording film surface of the optical disk medium 2, thus recording the information.

In the information playback system, the laser is activated at a power used for reading, and the laser is beamed to the recording film surface or the playback-only film surface, and information is played back. A playback circuit 23 applies discrimination on a playback signal 51 from the optical head 27 to provide a playback information code 52. The playback information code 52 later passes through a demodulation circuit to provide a playback information 53. Then, the main control circuit sends the playback information to the host computer 20.

The main control circuit 21 can be formed, for example, from a central processing unit (CPU), a ROM storing a program for the CPU, a ROM storing various types of data, and the like (not shown in the figure).

FIG. 6 illustrates an embodiment of an optical disk changer device that is used by mounting the optical disk magazine 12 in the device.

In this figure, the double-sided disk magazine 12 holds four optical disk media 2 and is mounted in the optical disk changer device with side A facing up.

The internal operations performed when side A of the disk medium 2d positioned lowermost in the disk magazine 12 will be described.

As described above, the elevator motor 33 is driven so that the spindle motor 28 and the optical head 27 supported by the head base in the optical disk changer device are positioned at the same height as the disk transport tray 5.

Then, the tray transport motor 35 is driven, and the tray pulling mechanism 36 is moved horizontally into the disk magazine, where it engages with the transport claim 8 at the end of the disk transport tray 5e. Then, the transport motor 35 is operated in reverse, and the disk transport tray 5e and the optical disk medium 2d are pulled in up to the center position of the spindle motor 28.

Then, the elevator motor 33 is operated, and the head base 32 is lifted slightly upward. The spindle motor 28 raises the optical disk medium 2 so that the optical disk medium 2d is raised slightly from the disk transport tray 5e. The damper 29 secures the optical disk medium 2 to the spindle motor 28. The optical disk medium 2d is raised slightly from the disk transport tray 5e to avoid contact between the optical disk medium 2d and the tray during rotation.

Then, as described above, the optical head 27 is positioned to a predetermined track position based on information from the host computer 20, and information recording/playback is performed.

Conversely, when the optical medium 2d is to be returned to the disk magazine 12, the spindle motor 28 is stopped to stop disk rotation. Then, damper 29 is disengaged, the head base is lowered slightly, and the optical disk medium 2d is mounted on the disk transport tray 5e. From this state, the tray transport motor 35 is operated, and the disk transport tray 5e supported by the tray pulling mechanism 36 is stored in the disk magazine 12.

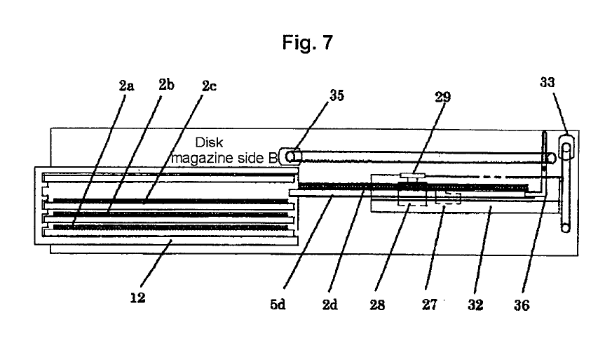

If the disk magazine 12 is holding all the disk transport trays 5, it can be removed from the optical disk changer device, turned upside-down, and mounted in the optical disk changer device. To perform recording/playback on side B, the opposite side from the side involved in the above description, the disk magazine 12 is mounted in the optical disk changer device with side B facing up, as shown in FIG. 7. In changing from side A to side B, each of the optical disk media 2 move to the disk transport tray 5 that was positioned above it when side A was facing up. The optical disk medium 2d moves to the disk transport tray 5d. To use side B of the disk medium 2d, operations similar to those used for side A of the disk medium 2d are performed to record and play back information.

The optical disk medium 2d is returned to the disk magazine 12 using operations similar to the operations performed for side A.

As described above, the disk magazine has 180 deg rotational symmetry, so the physical heights of the transport trays will stay the same regardless of which side is facing up. For example, the disk transport tray 5e in FIG. 6 has the same height as the disk transport tray 5a in FIG. 7. Thus, the information sent from the main control device 21 to the height position control circuit 30 will be just four sets of information if there are four disks. The same values can be used either for side A or side B.

In this embodiment, optical disk media are used as the information recording media. However, the present invention is not restricted to this and can be implemented in a similar manner for magnetic disk media, flexible disk media, and the like where both sides are used as information surfaces. Also, the optical disk media referred to here covers read-only optical disk media, write-once optical disk media, magneto-optical recording medium, phase-change recording media, dye-based recording media, and the like.

Also, the optical disk devices in the embodiments described above, provide both recording functions and playback functions, but it would also be possible to have devices that provide just one of these functions.

With a disk changer device and disk magazine as described in the embodiments above, recording and playback can be done for both sides of the disk magazine. Furthermore, both sides of the disk media can be used. As a result, more information can be recorded or played back compared to conventional disk changer devices.

What is claimed is:

1. A disk changer device comprising:
a disk magazine equipped with disk transport trays for mounting a plurality of disks;
a spindle motor for rotating said disks;
a head for recording on/playing back information from said disks mounted on said spindle motor; and
a tray pulling mechanism pulling said disk transport trays on which said disks are mounted from said disk magazine up to where said disks are at a disk rotation position;
wherein said disk magazine holds N disks and N+1 disk transport trays in an alternating manner along a vertical axis of said disk magazine;
said disk transport trays include grooves on both sides formed along a thickness axis of said trays, and a disk can be mounted on disk transport trays positioned on either side of said disk; and
said disk magazine can be turned upside-down to allow playback of information recorded on either side of said disks.

2. A disk changer device according to claim 1, wherein said disk magazine is formed with a rotationally symmetrical shape so that an outer shape of said disk magazine, as well as shapes and heights of said disk transport trays held therein remain unchanged when said disk magazine is turned upside-down.

3. A disk changer device according to claim 1, wherein said disk magazine is formed with a rotationally symmetrical shape so that an outer shape of said disk magazine and latch positions and shapes of said disk transport trays remain unchanged when said disk magazine is turned upside-down.

4. A disk changer device according to claim 2, wherein said disk magazine is formed with a rotationally symmetrical shape so that an outer shape of said disk magazine and latch positions and shapes of said disk transport trays remain unchanged when said disk magazine is turned upside-down.

5. A disk changer device according to claim 1, wherein:
a disk rotation position and said optical head are positioned in stages at height positions of disk transport trays on which said plurality of optical disk media are mounted;
a desired disk transport tray and an optical disk medium mounted thereon are pulled up to a disk rotation position;
said disk is clamped; and
said disk is rotated to a predetermined speed and recording and playback is performed with said disk medium.

6. A disk changer device according to claim 3, wherein:
a disk rotation position and said optical head are positioned in stages at height positions of disk transport trays on which said plurality of optical disk media are mounted;
a desired disk transport tray and an optical disk medium mounted thereon are pulled up to a disk rotation position;
said disk is clamped; and
said disk is rotated to a predetermined speed and recording and playback is performed with said disk medium.

7. A disk magazine comprising N disks and N+1 disk transport trays arranged in an alternating manner along a thickness axis of said disks wherein:
said disk transport trays includes grooves formed on both sides along a thickness axis thereof; and
a disk is capable of being mounted on disk transport trays positioned on either side of said disk.

8. A disk changer device comprising:
a disk magazine equipped with disk transport trays for mounting a plurality of disks; and
means for recording on and playing back information from said disks;
wherein said disk magazine holds N disks and N+1 disk transport trays in an alternating manner along a vertical axis of said disk magazine;
said disk transport trays comprising grooves on both sides formed along a thickness axis of said trays such that a disk can be mounted on disk transport trays positioned on either side of said disk; and
said disk magazine can be turned upside-down to allow playback of information recorded on either side of said disks.

9. A disk changer device according to claim 8, wherein said disk magazine is formed with a rotationally symmetrical shape so that an outer shape of said disk magazine, as well as shapes and heights of said disk transport trays held therein remain unchanged when said disk magazine is turned upside-down.

10. A disk changer device according to claim 8, wherein said disk magazine is formed with a rotationally symmetrical shape so that an outer shape of said disk magazine and latch positions and shapes of said disk transport trays remain unchanged when said disk magazine is turned upside-down.
